(19) United States
(12) Patent Application Publication
(10) Pub. No.: US 2016/0371457 A1
(43) Pub. Date: Dec. 22, 2016

(54) System and Method for Data Analyzing of Health-Related Data

(71) Applicant: Sonja Zillner, Munchen (DE)

(72) Inventor: Sonja Zillner, Munchen (DE)

(21) Appl. No.: 14/746,647

(22) Filed: Jun. 22, 2015

(51) Int. Cl. G06F 19/00

(52) U.S. Cl. CPC G06F 19/3443; G06F 19/322

(57) ABSTRACT

A data analyzing system for analyzing health-related data of a patient is provided. The system includes a data repository configured to store a semantic patient data model instantiated for each patient by episodic health-related data of the patient loaded from heterogeneous clinical data sources, by non-episodic health-related data of the patient loaded from at least one health monitoring device of the patient, or by a combination thereof. The system also includes a data analyzing unit configured to analyze at least one instantiated patient data model stored in the data repository in response to a query.

### TECHNICAL BACKGROUND

The present embodiments relate to a method and system for data analyzing of health-related data of a patient or a group of patients.

Due to changing patient demographics, the healthcare domain faces tremendous productivity challenges.

### SUMMARY AND DESCRIPTION

The scope of the present invention is defined solely by the appended claims and is not affected to any degree by the statements within this summary.

Solutions improving the quality of care such as personalized treatments or proactive care as well as solutions addressing the efficiency of care such as preventive care settings or increased transparency about the effectiveness of clinical processes are to be provided.

Accordingly, there is a need to provide a method and a system for analyzing health-related data of patients to address the efficiency and quality challenges in the healthcare domain.

According to a first aspect, a data analyzing system for analyzing health-related data of at least one patient includes a data repository adapted to store a semantic patient data model instantiated for each patient by episodic health-related data of the patient loaded from clinical data sources and/or by non-episodic health-related data of the patient loaded from at least one health monitoring device of the patient. The data analyzing system also includes a data analyzing unit adapted to analyze at least one instantiated patient data model stored in the data repository in response to a query.

In one embodiment of the data analyzing system according to the first aspect, the health-related data loaded from the heterogeneous clinical data sources and the health monitoring devices include unstructured health-related data provided in unstructured data formats including medical reports, medical images, medical videos and/or structured health-related data provided in structured data formats.

In an embodiment of the data analyzing system according to the first aspect, the system includes a data source connection unit having a semantic labeling subunit adapted to perform a semantic data enrichment of health-related data loaded from the heterogeneous clinical data sources and/or patient monitoring devices by semantic labeling.

In a further embodiment of the data analyzing system according to the first aspect, the data source connection unit is adapted to transform the data structure of data items of the loaded health-related data into the data structure of the semantic patient data model.

In a further embodiment of the data analyzing system according to the first aspect, the system includes a data access management unit adapted to limit access to data items of the loaded health-related data of a patient according to data access meta data.

In a still further embodiment of the data analyzing system according to the first aspect, the system includes a patient population mapping unit adapted to derive patient populations consisting of patients with similar health patterns based on the instantiated patient data models of patients stored in the data repository of the data analyzing system.

In a still further embodiment of the data analyzing system according to the first aspect, the health monitoring device includes a wearable or non-wearable health monitoring device attached to the patient and adapted to supply continuously structured and/or unstructured health-related data of the respective patient to the data source connection unit of the data analyzing system.

In a still further possible embodiment of the data analyzing system according to the first aspect, medical ontologies and/or standards are stored in the data repository of the data analyzing system.

In a still further embodiment of the data analyzing system according to the first aspect, the data source connection unit of the data analyzing system includes a patient identity mapping subunit, a schema analytics subunit, and a data storage locator subunit.

In a further embodiment of the data analyzing system according to the first aspect, the system includes a relationship management unit adapted to identify relationships between health-related data sets of the same patient or different patients stored in the data repository and adapted to store the identified relationships as meta data in the instantiated patient data models of the respective patients.

One or more of the present embodiments further provide, according to a second aspect, a health monitoring device for a data analyzing system according to the first aspect. The health monitoring device includes a health data generation unit adapted to generate non-episodic health-related data of a patient and a data interface adapted to upload the generated non-episodic health-related data to the data repository of the data analyzing system.

In an embodiment of the health monitoring device according to the second aspect, the health data generation unit of the patient monitoring device may include a first sensor unit adapted to provide cardio data and/or a second sensor unit adapted to provide EEG data and/or a third sensor unit adapted to provide tracking data of the patient's motions.

In a further embodiment of the health monitoring device according to the second aspect, the health data generation unit of the patient monitoring device includes a user interface adapted to input structured or unstructured health-related data of the patient by the patient or by a supervising user.

One or more of the present embodiments further provide, according to a third aspect, a method for data analyzing of health-related data of at least one patient. The method includes receiving episodic health-related data of the patient from at least one clinical data source and/or non-episodic health-related data of the patient from at least one health monitoring device. The method also includes instantiating a semantic patient data model of the patient by the received health-related data of the patient and analyzing the instantiated patient data model in response to a query.

### BRIEF DESCRIPTION OF THE FIGURES

FIG. 1 shows a block diagram of an exemplary embodiment of a data analyzing system;

FIG. 2 shows a further embodiment of a data analyzing system;

FIG. 3 illustrates different exemplary kinds of health-related data processed by the data analyzing system;

FIG. 4 shows a schematic architecture of an exemplary embodiment of a data analyzing system;

FIG. 5 shows a block diagram of an exemplary embodiment of a health monitoring device;

FIG. 6 illustrates a further exemplary embodiment of a data analyzing system; and

FIG. 7 shows a flowchart illustrating an exemplary embodiment of a data analyzing method.

### DETAILED DESCRIPTION

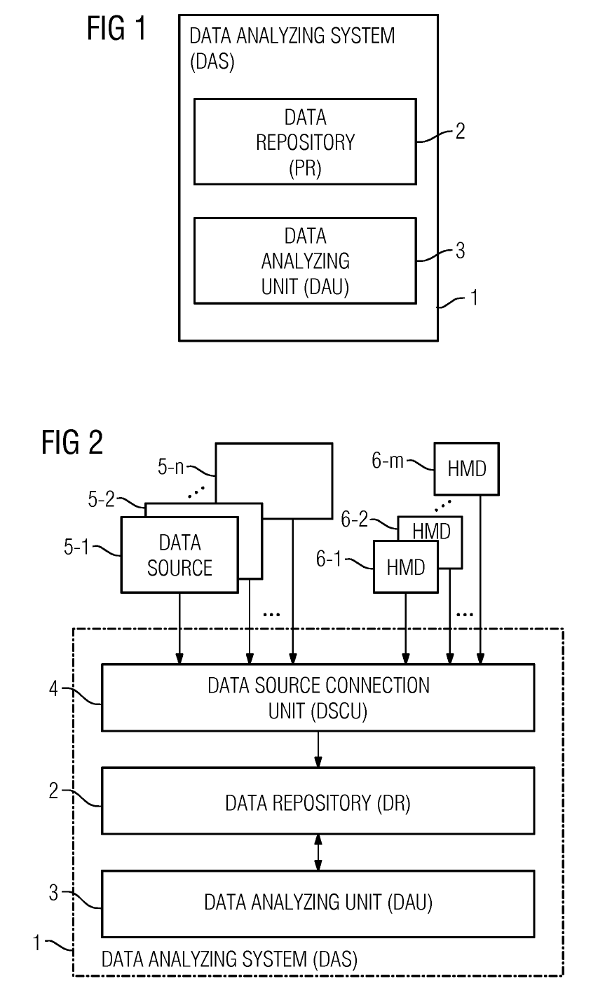

FIG. 1 shows a first exemplary embodiment of a data analyzing system 1 according to a first aspect. The illustrated data analyzing system 1 includes a data repository 2 and a data analyzing unit 3. The data analyzing system 1, as shown in FIG. 1, is provided for analyzing health-related data (HRD) of at least one patient or a group of patients. The data analyzing system 1 includes the data repository 2. The data repository 2 is adapted to store a semantic patient data model (PDM) instantiated for each patient P by episodic health-related (HRD) data of the patient P loaded from heterogeneous clinical data sources, and/or non-episodic health-related data of the patient loaded from at least one health monitoring device of the patient. The data analyzing unit 3 of the data analyzing system 1, as shown in FIG. 1, is adapted to analyze at least one instantiated patient data model stored in the data repository 2 in response to a query. The data analyzing system 1, as shown in FIG. 1, allows a seamless integration of episodic and non-episodic health-related data of a patient or a plurality of patients. The episodic health-related data is collected and stored in a case-based manner (e.g., all health-related data captured in the context of a patient's hospital stay). This episodic health-related data relates to a particular reason or event, such as anamneses or diagnostic events, and is collected in the context of a particular episode. Such an episode is, for example, a stay in a hospital or a visit to a doctor. In contrast, non-episodic health-related data is formed by any health-related data that may be collected continuously without particular reason.

FIG. 2 shows a block diagram of a possible embodiment of a data analyzing system 1 according to the first aspect. As shown in FIG. 2, the data analyzing system 1 includes in the illustrated embodiment a data source connection unit 4 forming an interface to a plurality of heterogeneous clinical data sources 5-i and a plurality of health monitoring devices 6-i. The data source connection unit 4 is adapted to upload episodic health-related data of one or several patients from the heterogeneous clinical data sources 5-i. Further, the data source connection unit 4 is adapted to upload non-episodic health-related data of the patient or a group of patients from at least one health monitoring device 6-i attached to the patients. The health-related data loaded from the heterogeneous clinical data sources 5-i and the health monitoring devices 6-i may include unstructured health-related data provided in unstructured data formats and/or structured health-related data provided in predetermined structured data formats. The unstructured health-related data may include, for example, medical reports, medical images or medical videos. The health-related data received from the health monitoring devices 6-i may be supplied to the data source connection unit 4 in a structured or unstructured data format. In a possible embodiment, the data source connection unit 4 is adapted to transform the data structure of data items of the received loaded health-related data into a data structure of the patient data model stored in the data repository 2 of the data analyzing system 1. In a possible embodiment, the data source connection unit 4 includes a semantic labeling subunit adapted to perform a semantic data enrichment of health-related data loaded from the heterogeneous data sources or patient monitoring devices by semantic labeling. The semantic labeling subunit may be adapted to enable the extraction and semantic labeling of information or data from unstructured data items. For example, in accordance with the type of the input data (e.g., image data, text data, and a minimal set of meta data informing the system about relevant context information, such as the focus of diagnostic intervention), the extraction and semantic labeling of unstructured data may be accomplished. The semantic labeling subunit may be configured to extract meaningful information entities. For example, for each type of unstructured data items, a dedicated set of information extraction algorithms that is provided to extract meaningful entities of the received input data items may be available. For example, NLP algorithms may be used to extract information or data about diseases and symptoms from a radiology report. Alternatively, image segmentation algorithms may be used to locate organ information in 3D medical images. The extracted meta data may be stored in the context of the respective instantiated patient data model of the patient. In a possible embodiment, the semantic labeling subunit may further perform an interpretation of meaningful information entities. In a possible embodiment, semantic algorithms that inform the system of how to interpret the extracted meaningful entities (e.g., by classifying normal or abnormal finding) are provided. Further, the semantic algorithms may be provided to inform the system how to populate the extracted entities in the integrated data model. The inferred interpretation may be captured by dedicated meta data labels linked to the extracted entities. In a possible embodiment, the extracted meta data is stored in the context of the respective instantiated patient data model. In a possible embodiment, the semantic labeling subunit of the data source connection unit 4, as shown in FIG. 2, may perform semantic labeling of all received unstructured items uploaded from a data source or a health monitoring device.

The data repository 2 may store in a possible embodiment medical ontologies and/or standards to enable seamless data integration in a standardized manner. Further, the data repository 2 may be configured to store a semantic patient data model of a patient that may be instantiated by received health-related data of the respective patient. The semantic patient data model is an integrated patient-centered data model that forms the basis to store the heterogeneous health-related data (HRD) received from the different data sources in a patient-centered integrated and longitudinal manner. Beside the semantic patient data model provided in the data repository 2, the data repository 2 is adapted to store a set of all patient instance data models of the different patients. The patient models including a semantic patient data model are an integrated patient-centered data model that allows to store the longitudinal patient data in a semantic manner and a patient instance data model or instantiated patient data model. A patient instance data model is an instance of the semantic patient data model that encompasses any health-related data and related meta data captured in the context of a particular patient. The data repository 2 includes an integrated data platform having data storage components adapted to store the health-related data received from the heterogeneous data sources 5-i and the health-related data received from the health monitoring devices 6-i. A data platform may, for example, include a PACS component for storing medical images or data storages for storing genetic test results. Through dedicated meta data describing the storage location of an unstructured data item, such as a medical image in the respective instantiated patient data model, the linkage between unstructured data items and patient instance data model is made explicit.

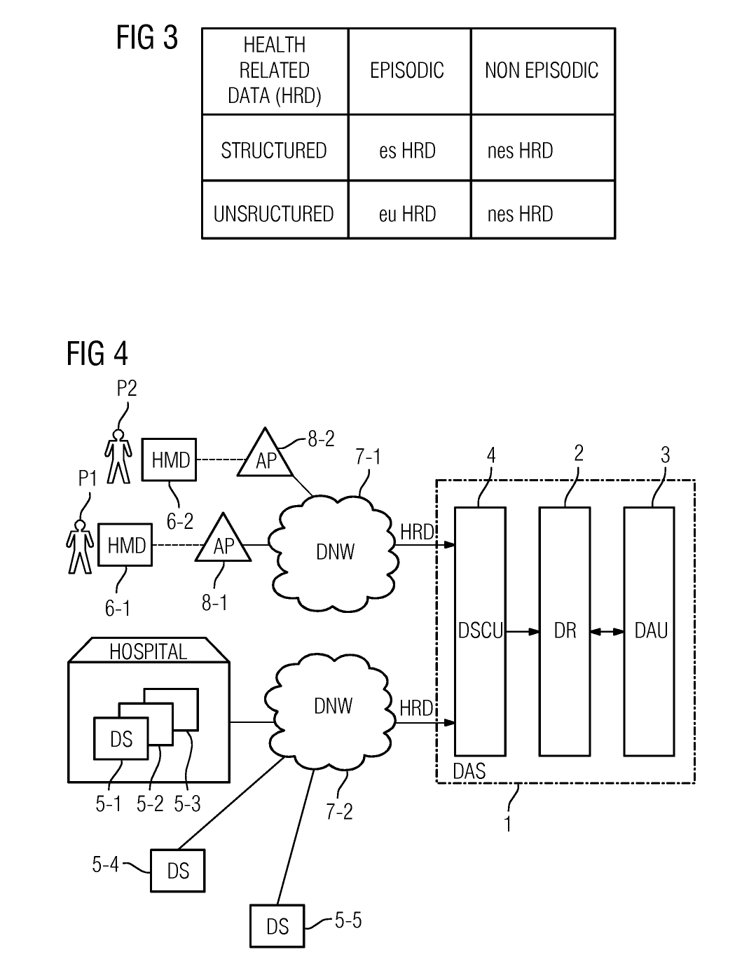

FIG. 3 shows different exemplary types of health-related data received and processed by the data source connection unit 4 of the data analyzing system 1. The received health-related data (HRD) may include episodic data (esHRD) loaded from heterogeneous data sources 5-i or non-episodic data (nesHRD) received from health monitoring devices 6-i. The episodic health-related data (esHRD) and the non-episodic health-related data (nesHRD) may both include structured or unstructured data. The data source connection unit 4 may include an internal transformation unit adapted to transform the data structure of data items of received structured health-related data (HRD) into an internal data structure of the respective semantic patient data model (PDM). In a possible embodiment, the data source connection unit 4 is further adapted to transform unstructured health-related data into structured health-related data. The data source connection unit 4 further includes, in an embodiment, a semantic labeling subunit that performs a semantic data enrichment of the received health-related data (HRD) by semantic labeling. The transformed and enriched health-related data is then stored by the data source connection unit 4 in the data repository 2 of the data analyzing system 1 for the respective patients.

In a further possible embodiment, the data source connection unit 4 further includes a patient identity mapping subunit and/or a schema analytics subunit and/or a data storage locator subunit.

The patient identity mapping subunit is adapted to provide that all uploaded data items are stored in the context of a particular patient P the uploaded data items refer to. The patient identity mapping subunit is adapted in a possible embodiment to extract any information or data of the uploaded data sources indicating to which patient identity a particular data item is referring to and links the meta data to the particular patient instance data model of the respective patient. For each type of data source, different versions enabling the patient identity mapping may be available. For example, given a DICOM image, the patient identity mapping subunit may extract from the associated meta data in the DICOM header the patient information and uses this identifier to locate and subsequently map the patient instance data in the patient data model.

The data source connection unit 4 further includes a schema analytics subunit. If a data item is represented in a structured data format, the schema analytics subunit may be adapted to translate the underlying data structure of the data item into the data structure of the patient data model. This may be accomplished by identifying similar data schema elements. This may be achieved by comparing the data structure of the newly uploaded data sources with the data structures of all already stored patient instance data. By identifying similar data schema elements, either the user or the machine may make proposals of data structure mappings to the semantic patient data model. Corresponding likely semantic annotations (e.g., references to existing medical ontologies and standards) may also be provided. For example, when the lab data repository of a particular hospital is uploaded to a storage component of the data repository 2, the originating data items (e.g., single test results) may be mapped and stored in the semantic patient data model or respectively into the patient instance model. When monitoring health-related data of a set of patients captured, for example, by a health monitoring application program and stored in a health application platform is uploaded by the data source connection unit 4, the underlying data structure of the health application program may be mapped to the internal data structure of the semantic patient data model provided in the data repository 2. In order to enable a high quality and reliability, the schema analytics subunit of the data source connection unit 4 may provide a user interaction process for verification of data schema mappings and semantic annotations.

The data source connection unit 4 may further include a data storage locator subunit. If a data item may not be represented in structured format in the respective patient instance data model, the data storage locator subunit may extract the meta data characterizing the data item and meta data describing a storage location of the data item where the data item is stored. The data storage locator subunit may add the generated meta data to the respective patient instance data model of the patient.

FIG. 4 shows a schematic architecture of a possible embodiment of the data analyzing system 1 according to an aspect of one or more of the present embodiments. As shown in FIG. 4, the data analyzing system 1 or data analyzing apparatus 1 may be connected to one or several data networks 7-1, 7-2 that are adapted to supply health-related data (HRD) in structured and/or unstructured form to the data source connection unit 4 of the data analyzing system 1. In the example illustrated in FIG. 4, two different patients P1, P2 carrying mobile health monitoring devices 6-1, 6-2 are shown. The mobile health monitoring devices 6-1, 6-2 are connected via a wireless interface to access points 8-1, 8-2. The health monitoring devices 6-I, as illustrated in FIG. 4, may include mobile wearable healthcare devices carried by the patient and connected to the data access point of a data network via a wireless link. As shown in FIG. 4, the data network 7-1 includes two access points 8-1, 8-2 to receive health-related data (HRD) from the patients P1, P2. The data network 7-1 is connected to the data source connection unit 4 of the data analyzing system 1 and supplies structured and/or unstructured health-related data (HRD) of the patients P1, P2 to the data source connection unit 4. In the exemplary embodiment in FIG. 4, the data source connection unit 4 receives further health-related data (HRD) via a second data network 7-2 connected to different heterogeneous data sources 5-i that may be located in different databanks or data silos. In the example illustrated in FIG. 4, three different data sources 5-1, 5-2, 5-3 are stored in a database of a hospital, whereas the data sources 5-4, 5-5 are located at other storage locations (e.g., in a storage component of a doctor visited by a patient P). The data sources 5-i may provide episodic health-related data of the two patients P1, P2. For example, if a patient P1 has visited the hospital, heterogeneous data sources 5-i of the hospital may provide episodic health-related data of the patient P1 to the data analyzing system 1. Further, if, for example, a patient P2 has visited his doctor, a data source 5-4 stored in a data memory of a computer of the respective doctor may supply episodic health-related data from the visit to the data analyzing system 1 via the data network 7-2.

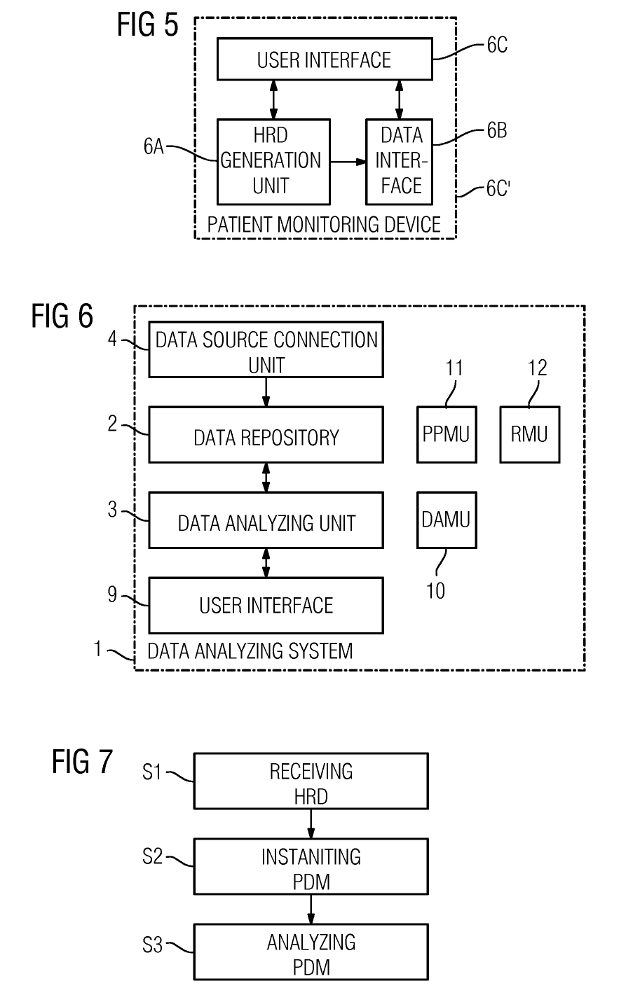

FIG. 5 shows a block diagram of a possible exemplary embodiment of a health monitoring device 6-i according to a further aspect. The health monitoring device 6-i may in a possible embodiment be a fitness monitoring device. In the shown embodiment, the health monitoring device 6-i may include a health-related data (HRD) generation unit 6A and a data interface 6B. The health-related data generation unit 6A may be adapted to generate non-episodic health-related data of a patient P. The health-related data generation unit 6A may include one or several sensor units to provide different health-related data (HRD) of a patient P to which the patient monitoring device 6-i is attached. For example, the health-related data generation unit 6A may include a sensor unit adapted to provide cardio data of the patient P. The cardio data may include a heartbeat frequency and/or a complete cardiographic signal of the respective patient.

Further, the health-related data generation unit 6A may include a further sensor for supplying electrical potentials detected by electrodes attached to the patient's head to monitor brain activity. The health-related data generation unit 6A may further include a sensor for tracking data of a patient's motions or movements. In a further possible embodiment, the health-related data generation unit 6A may be connected to a user interface 6C adapted to input structured or unstructured health-related data (HRD) of the patient P by the patient P himself or a supervising user such as a doctor. In a possible embodiment, a patient P or another user may provide an unstructured text document describing the behavior or condition of the patient during generation of the health-related data (HRD) by the generation unit 6A. For example, a patient P may dictate into a microphone of the user interface 6C during the generation of the cardio data by a sensor unit, whether the patient P feels well or uncomfortable. The patient or health monitoring device 6-i may in a possible embodiment be a mobile device carried by the patient P during different sports activities. The sensor data generated during these activities may be supplied as non-episodic data (nesHRD) via a data network to the data source connection unit 4 of the data analyzing system 1, as illustrated in FIG. 4. The transported electrocardio data may be semantically enriched and structured and then stored in the data repository 2 of the data analyzing system 1 for further processing and evaluation. The data analyzing unit 3 of the data analyzing system 1 may have access to the data repository 2 and analyze the received episodic health-related data (esHRD) of the patient P but also taking into account non-episodic health-related data (nesHRD) received from one or several other data sources 5-i. For example, a patient P that has visited a hospital (e.g., after a heart attack) may get a health monitoring device 6-i carried by the patient P during sports activities. The generated non-episodic health-related data (nesHRD) loaded to the data analyzing system 1 may be used to instantiate a semantic patient data model (PDM) of the patient P. Further, the episodic health-related data (esHRD) stored in a data source of the hospital may also be used for instantiating the patient data model (PDM) of the same patient P. In a possible embodiment, the different instances of the patient data model (PDM) may be evaluated by the data analyzing unit 3 to evaluate a long-term physical development of the patient P. The data analyzing unit 3 may be adapted to analyze the at least one instantiated patient data model stored in the data repository 2 in response to a query. In a possible embodiment, a corresponding query may be input by a user interface of the data analyzing system 1 (e.g., by a supervising user). In a further possible embodiment, the data analyzing unit 3 may receive a query for performing the evaluation of the instantiated patient data models of a patient from the patient P himself (e.g., by sending a query input in the user interface 6C of the health monitoring device 6-i). A patient P performing a physical exercise or sports activity may request evaluation of the generated cardio data during the sports activity taking into account also the health-related data stored in a data source of a hospital which the patient did visit previously (e.g., after a heart attack).

FIG. 6 shows a further possible exemplary embodiment of a data analyzing system 1. In the illustrated embodiment, the data analyzing system 1 also includes a user interface 9 that allows a supervising user such as a doctor or a scientist to input a query into the data analyzing system 1. In a possible embodiment, the data analyzing system 1, as illustrated in FIG. 6, may be implemented in a data analyzing apparatus such as a server. The data analyzing apparatus 1, as shown in FIG. 6, includes the data source connection unit 4, a data repository 2, a data analyzing unit 3 and a user interface 9. The data analyzing unit 3 may be implemented by one or several processors.

In the shown embodiment, the data analyzing apparatus or data analyzing system 1 includes a data access management unit 10 that may be adapted to limit access to data items of the loaded health-related data of a patient according to data access meta data. The data access management unit 10 may be provided with a privacy and security mechanism using meta data providing the appropriate data access and usage rights. The data access management unit 10 may include an access meta data labeling engine that requests for each uploaded data source the set of meta data specifying the underlying data privacy and security. The meta data may indicate who is allowed to access and use which data sources under which constraints for different data items. The data access meta data may either be requested via a user dialog or automatically generated by extracting and aggregating privacy meta data of similar data assets already stored in a storage component and subsequently presented to a user for approval. The data access management unit 10 may further include a data access execution engine. The data access execution engine may prove for each requested data item whether the data access and usage constraints of the requesting user or application are compliant with the corresponding data access meta data. The data access execution engine returns the requested data only if the data access and usage constraints of the requesting user or application are compliant with the corresponding data access meta data. A data request may be triggered by a human user or by a machine by specifying a set of query terms and/or query parameters.

In a further possible embodiment, the data analyzing system 1, as illustrated in FIG. 6, may include a patient population mapping unit 11. The patient population mapping unit 11 may be adapted to derive patient populations consisting of patients P with similar health patterns based on the instantiated patient data models (PDMs) of the patients stored in the data repository 2. The patient population mapping unit 11 may, for example, identify similar patient populations of patients with similar disease patterns and may document this by attaching generated corresponding meta data to the respective patient instance models.

In a further possible embodiment, the data analyzing system 1 may include a relationship management unit 12, as shown in FIG. 6. The relationship management unit 12 may be adapted to identify relationships between health-related data of patients stored in the data repository 2 and may be further adapted to store the identified relationships as meta data in the instantiated patient data models (PDMs) of the respective patients. The relationship management unit 12 may, for example, identify temporal relationships on data item level as well as on finding level. A finding is an information entity extracted from the original data item. The relationship management unit 12 may identify relationships on data item level or finding level on any data stored in the context of one patient P and stores this meta data in accordance to the patient instance model.

FIG. 7 shows a flowchart of an exemplary embodiment of a method for data analysis of health-related data (HRD) of at least one patient P according to a further aspect. In act S1, episodic health-related data of the patient or a group of patients is received from at least one clinical data source, and/or non-episodic health-related data of the patient or patients is received from health monitoring devices. In act S2, the semantic patient data model (PDM) of the patient P is instantiated by the received health-related data of the patient. The instantiated patient data model may be analyzed in response to a data query in act S3.

In a possible embodiment, the method may be performed in a process including different process phases such as an initializing phase, an enhancing phase and a usage phase.

In the initializing phase, new data content of the data items are uploaded in the data repository 2. In the initializing phase, data sources or data monitoring devices supplying health-related data (HRD) intended to be uploaded into the data repository 2 may be selected. The selection of the relevant data sources and/or patient monitoring devices may be performed by a user such as a supervising user or a patient or by a machine or application via a dedicated API. The patient identifier mapping subunit of the data source connection unit 4 may provide that any information or data item relevant for a particular patient is linked to the particular patient model instance. If the data item is in structured data format, the schema analytics component subunit may map the original data sources to the patient data model. In contrast, if the received data item is unstructured, the data storage locator subunit of the data source connection unit 4 may semantically align the received data item with the patient data model.

A semantic labeling subunit of the data source connection unit 4 may semantically label all newly integrated unstructured data items. The semantic labeling subunit processes all uploaded unstructured data items by using an appropriate IE algorithm.

The relationship management unit 12 may compute in a possible embodiment for all patient instance data models the temporal linkages of all stored or linked data sources/items and may then store this temporal meta data within the corresponding patient instance data model. An access meta data labeling engine of the data access management unit 10 may extract in a possible embodiment for each uploaded data item the corresponding data access meta data.

In the following enhancing phase, the stored health-related data is enhanced by data analytics applications. In a possible embodiment, the patient population mapping unit 11 may re-compute the patient population that each patient or patient instance model is belonging to in accordance to the updated patient instance data. The level of detail of patient population may in a possible embodiment be manually adapted. In a possible embodiment, the user interface 9 allows a clinical expert or user to specify relevant parameters and settings for gathering meaningful patient populations. In this embodiment, the data analyzing system 1 may be used for performing clinical studies over a huge group of different patients that may be in- or outside a hospital. Further, in the enhancing phase, a data analytics execution engine may execute a set of data analytics application on top of health-related data stored in the repository. Meta data describing the semantics of the results of each analytics algorithm may be stored in the corresponding patient instance data models.

In a usage phase, patient data sets may be accessed and processed. A data access execution engine that may be accessed via API or a user interface provides a way to query the data content of interest by specifying structured query requests similar to SPARQL determining the data scope of interest by specifying the parameters and categories. The data access execution engine may return data items that are compliant with the specified data access meta data.

The method and system for analyzing health-related data allows health-related data to be integrated by providing data privacy and security aspects. In the system, patient-related data content that provides a standardized representation of structured or unstructured data content is uploaded to the data repository 2. Further, privacy aspects are provided by the system, and temporal relationships are made explicit for subsequent queries. The system provides for extracting and interpreting meaningful information entities captured in unstructured data sources in a standardized way. Further, the system provides for extracting temporal meta data that allows the longitudinal nature of a patient data to be made explicit. Further, the system provides for iteratively building up a knowledgebase by labeling data analytics results such as patient population information in a standardized way. The system provides a mechanism for an automatic coordination of a workflow that allows a seamless integration of episodic and non-episodic health-related data by providing data privacy, security and data quality standards. With the system according to one or more of the present embodiments, the collected heterogeneous health-related data from different data sources or monitoring devices may be enriched by sufficient meta data enabling a transparent management of the health-related data in accordance to contextual requirements such as privacy or security. The data analyzing system 1 according to one or more of the present embodiments provides that health-related data is available in an integrated and transparent manner for subsequent advanced applications such as clinical decision or diagnose support applications. The method and system according to one or more of the present embodiments provides a way to significantly improve a seamless access to health-related data in high quality, which is a prerequisite for advanced health data analytics applications such as comparative effective research, patient profiling, and advanced clinical decision support applications. The system provides an automated and patient-centered health data collection and aggregation in a standardized manner.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A data analyzing system for analyzing health-related data of a patient, the system comprising:
a data repository configured to store a semantic patient data model instantiated for each patient by episodic health-related data of the patient loaded from at least one heterogeneous clinical data source, by non-episodic health-related data of the patient loaded from at least one health monitoring device of the patient, or by a combination thereof; and
a data analyzing unit configured to analyze at least one instantiated patient data model stored in the data repository in response to a query.

2. The data analyzing system of claim 1, wherein the health related data loaded from the at least one heterogeneous clinical data source and the at least one health monitoring device comprises unstructured health-related data provided in unstructured data formats including medical reports or medical images, medical videos, structured health-related data provided in structured data formats, or any combination thereof.

3. The data analyzing system of claim 2, further comprising a data source connection unit, the data source connection unit comprising a semantic labeling subunit configured to perform a semantic data enrichment of health-related data loaded from the at least one heterogeneous clinical data source, the at least one health monitoring device, or a combination thereof by semantic labeling.

4. The data analyzing system of claim 3, wherein the data source connection unit is configured to transform a data structure of data items of the loaded health-related data into a data structure of the semantic patient data model.

5. The data analyzing system of claim 1, further comprising a data access management unit configured to limit access to data items of the loaded health-related data of a patient according to data access meta data.

6. The data analyzing system of claim 1, further comprising a patient population mapping unit configured to derive patient populations consisting of patients with similar health patterns based on the instantiated patient data models of patients stored in the data repository of the data analyzing system.

7. The data analyzing system of claim 1, wherein the at least one health monitoring device comprises a wearable or non-wearable health monitoring device attached to the patient and configured to supply continuously structured, unstructured, or continuously structured and unstructured health-related data of the respective patient to the data source connection unit of the data analyzing system.

8. The data analyzing system of claim 7, wherein the health monitoring device comprises a wearable or non-wearable health monitoring device connected to a data access point of a data network via a wireless link, and
wherein the data network is connected to the data source connection unit of the data analyzing system to provide structured, unstructured, or structured and unstructured health related data of the respective patient to the data source connection unit of the data analyzing system.

9. The data analyzing system of claim 1, wherein medical ontologies, medical standards, or medical ontologies and standards are stored in the data repository.

10. The data analyzing system of claim 3, wherein the data source connection unit comprises:
a patient identity mapping subunit;
a schema analytics subunit; and
a data storage locator subunit.

11. The data analyzing system of claim 1, further comprising a relationship management unit configured to:
identify relationships between health-related data sets of the same patient or different patients stored in the data repository; and
store the identified relationships as meta data in the instantiated patient data models of the respective patients.

12. A health monitoring device for a data analyzing system, the data analyzing system comprising a data repository configured to store a semantic patient data model instantiated for each patient by episodic health-related data of the patient loaded from heterogeneous clinical data sources and instantiated for each patient by non-episodic health-related data of the patient loaded from the health monitoring device, the data analyzing system further comprising a data analyzing unit configured to analyze at least one instantiated patient data model stored in the data repository in response to a query, the health monitoring device comprising:
a health data generation unit configured to generate the non-episodic health-related data of the patient; and
a data interface configured to upload the generated non-episodic health-related data to the data repository of the data analyzing system.

13. The health monitoring device of claim 12, wherein the health monitoring device comprises a user interface configured to input structured, unstructured, or structured and unstructured health-related data of the patient by the patient or supervising user.

14. A method for data analyzing health-related data of a patient, the method comprising:
receiving episodic health-related data of the patient from at least one clinical data source, non-episodic health-related data of the patient from at least one health monitoring device, or a combination thereof;
instantiating, by an analysis unit, a semantic patient data model of the patient by the received health-related data of the patient; and
analyzing, by the analysis unit, the instantiated patient data model in response to a query.
